(19) United States
(12) Patent Application Publication
(10) Pub. No.: US 2017/0223157 A1
(43) Pub. Date: Aug. 3, 2017

(54) PROCESSING METHOD AND SYSTEM OF MOBILE TERMINAL

(71) Applicants: LE HOLDINGS (BEIJING) CO., LTD., Beijing (CN); Lemobile Information Technology (Beijing) Co., Ltd, Beijing (CN)

(72) Inventor: Mengmeng CAO, Beijing (CN)

(21) Appl. No.: 15/236,353

(22) Filed: Aug. 12, 2016

Related U.S. Application Data
(63) Continuation of application No. PCT/CN2016/089333, filed on Jul. 8, 2016.

(30) Foreign Application Priority Data
Feb. 1, 2016 (CN) 201610070099.1

(51) Int. Cl. H04M 1/02; H04L 12/26

(52) U.S. Cl. CPC H04M 1/0254; H04L 43/16; H04W 88/02

(57) ABSTRACT

An embodiment of the present disclosure discloses a processing method and a system of a mobile terminal. The method comprises: receiving a card slot ejecting command when determining that the card slot is dosed; generating a control message according to a card slot ejecting command, and sending the control message to a mechanical device; and ejecting the card slot out through a first sensor of the mechanical device. The mechanical device automatically controls the ejecting of the card slot, and it is not needed to manually take out the card slot by using a card pin. The operation is convenient, and time is saved.

### CROSS-REFERENCE TO RELATED APPLICATIONS

The present disclosure is a continuation application of International Application PCT/CN2016/089333 filed on. Jul. 8, 2016, which claims priority to Chinese Patent Application No. 201610070099.1, entitled “PROCESSING METHOD AND SYSTEM OF MOBILE TERMINAL”, filed on Feb. 1, 2016, the entire contents of all of which are incorporated herein by reference.

### FIELD OF TECHNOLOGY

The present disclosure generally relates to the field of mobile phones, in particular to a processing method of a mobile terminal and a system.

### BACKGROUND

Mobile terminals have become necessary communication tools for information interaction among users. In order to distinguish a uses personal information, taking mobile phones as an example, mobile phone cards are defined as a user identity. In the earliest mobile phones, batteries were usually not detachable, and mobile phone cards were usually installed in card slots between the batteries and the mobile phone main boards.

In order to reduce the trouble of detaching batteries for users to replace the mobile phones, the USIM/SIM card slots are shaped like trays; the mobile phone cards are placed into the trays; and then, the trays are inserted into one side of the mobile phone. Such method allows convenience for insertion of the mobile phone card, and only a slight push is needed. However, when replace the mobile phone card needs to be replaced, usually a similar “pin” is needed to push the mobile phone card.

However, users adopting such mode need to carry a card pin; without the card pin, the card slot cannot be taken out. Moreover, the operation of using the card to take out the card slot is complicated.

Therefore, the problem to be urgently solved by a person in the art is to provide a processing method and system of a mobile terminal to solve the problem of inconvenience caused by taking out the card slot with the card pin.

### SUMMARY

An embodiment of the present disclosure discloses a processing method and a system of a mobile terminal to solve the problem of inconveniently carrying the card pin in the prior art.

According to an embodiment of the present disclosure, there is provided a method for processing a mobile terminal, wherein, the mobile terminal comprises a card slot and a mechanical device for controlling, the card slot; and the method comprises:
receiving a card slot ejecting command when determining that the card slot is closed;
generating a control message according to the card slot ejecting command, sending the control message to the mechanical device;
and ejecting the card slot out through a first sensor of the mechanical device.

According to an embodiment of the present disclosure, there is provided a mobile terminal, wherein, the mobile terminal comprises a card slot and a mechanical device for controlling the card slot; and: at least one processor; and a memory communicably connected with the at least one processor for storing instructions executable by the at least one processor, wherein execution of the instructions by the at least one processor causes the at least one processor to:
receive a card slot ejecting command when determining that the card slot is closed;
generate a control message according to the card slot ejecting command, and sending the control message to the mechanical device;
eject the card slot out through a first sensor of the mechanical device.

According to an embodiment of the present disclosure, there is provided a computer program, comprising computer readable codes, wherein the computer readable codes run on a mobile terminal so that the mobile terminal executes any one processing method of a mobile terminal above.

According to an embodiment of the present disclosure, there is provided a computer readable medium storing the computer program above.

The embodiment of the present disclosure receives the card slot ejecting command when determining that the card slot is closed, generates the control message according to the card slot ejecting command, sends the control message to a mechanical device, and springs the card slot out through a first sensor of the mechanical device, so that when the card slot is dosed, the mechanical device automatically controls the ejecting of the card slot on the basis of the ejecting command, and it is not needed to manually take out the card slot by using a card pin. The operation is convenient, and time is saved.

### BRIEF DESCRIPTION OF THE DRAWINGS

To clearly describe the technical solution in the embodiments of the present disclosure or in the prior art, the following are brief introductions of the attached drawings used to describe the technology in the embodiments or in the prior art. Obviously, the attached drawings described below involve some embodiments of the present disclosure. For a person skilled in the art, other drawings can be obtained according to those drawings without creative labor.

FIG. 1 is a step flowchart of a processing method of a mobile terminal according to an embodiment of the present disclosure;

FIG. 2 is a step flowchart of a processing method of a mobile terminal according to another embodiment of the present disclosure;

FIG. 3 is a step flowchart of a query about the card slot state according to one embodiment of the present disclosure;

FIG. 4 is a state diagram of a card slot in an ejected state according to an embodiment of the present disclosure;

FIG. 5 is a state diagram of a card slot in a closed state according to an embodiment of the present disclosure;

FIG. 6 is a structural block diagram of a processing system of a mobile terminal according to an embodiment of the present disclosure;

FIG. 7 is a structural block diagram of a s processing system of a mobile terminal according to another embodiment of the present disclosure;

FIG. 8 schematically illustrates a block diagram of a mobile terminal for executing the method according to the present disclosure; and

FIG. 9 schematically illustrates a storage unit for holding or carrying program codes for realizing the method according to the present disclosure.

### DESCRIPTION OF THE EMBODIMENTS

To clarify the objectives, technical solutions and advantages of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, a person skilled in the art can obtain other embodiments without creative labor, which shall all fall within the protection scope of the present disclosure.

The card slot in the mobile terminal is usually pushed out by using a card pin. It is inconvenient to carry the card pin. In the case of having a card pin, the card slot cannot be taken out, and the operation of inserting the card pin to take out the card slot is very complicated. A core concept of the present disclosure is a design of a mechanical device. An upper application sends an ejecting command so that the mechanical device automatically springs the card slot out.

### Embodiment 1

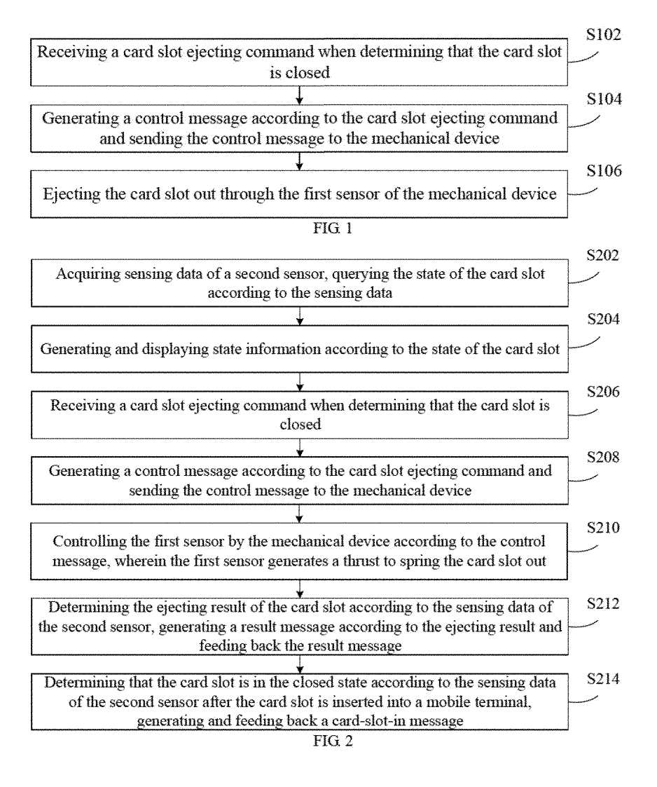

Refer to FIG. 1, which illustrates a step flowchart of a processing method of a mobile terminal according to an embodiment of the present disclosure. The method may specifically include the following steps.

Step S102: receiving a card slot ejecting command when determining that the card slot is closed.

The mobile terminal can have a smart card such as a USIM/SIM inserted in a tray through the card slot; where the card slot is in the closed state when inserted into the mobile terminal, and the card slot is in the ejected state after leaving the mobile terminal. The card slot in the closed state can spring out to leave the mobile terminal, and the card slot conespondingly in the ejected state can also be re-inserted into the mobile terminal. Wherein, the mobile terminal can include a mobile system with a smart card, such as a mobile phone, a tablet computer, etc.

In the embodiment, in order to solve the problem of inconvenience in taking out the card slot by using a card pin and to ensure that the configured mobile terminal can spring the card slot out automatically, the card slot of the mobile terminal is provided with a mechanical device, and the mechanical device is used for controlling the card slot, namely ejecting out the card slot in the closed state. Therefore, the state of the card slot can be acquired; when determining that the card slot is closed, a user can select to spring the card slot out, and accordingly, a card slot ejecting command is received.

To ensure that the user conveniently controls the card slot to spring oat automatically, the system setting of the operating system of the mobile terminal can be configured with a card-slot ejecting system, namely directly displaying the setting of the card slot ejecting in a setting interface, and the user can trigger the setting to send a card slot ejecting command.

Step S104: generating a control message according to the card slot ejecting command and sending the control message to the mechanical device.

Step S106: ejecting the card slot out through a first sensor of the mechanical device.

After the ejecting command is received, the ejecting command is converted into the control message, and the control message is sent to the mechanical device through a bottom interface. In this embodiment, the card slot is configured with a mechanical device which controls the card slot to spring out automatically. The mechanical device includes a first sensor. The mechanical device can drive the first sensor to generate an instant thrust according to the control message, and spring the card slot module out through the instant thrust.

The embodiment of the present disclosure receives the card slot ejecting command when determining that the card slot is closed, generates the control message according to the card slot ejecting command, sends the control message to a mechanical device, and springs the card slot out through the first sensor of the mechanical device, so when the card slot is closed, the mechanical device automatically controls the ejecting of the card slot on the basis of the ejecting command, and it is not needed to manually take out the card slot by using a card pin. The operation is convenient, and time is saved.

### Embodiment 2

Refer to FIG. 2, which illustrates a step flowchart of a processing, method of a mobile terminal according to another embodiment of the present disclosure. The method may specifically include the following steps.

Step 202: acquiring sensing data of a second sensor, and querying the state of the card slot according to the sensing data.

The card slot of the mobile terminal is also designed with a second sensor. The second sensor is used for measuring the current pressure on the card slot, and uploads the measured pressure data to an upper application through a bottom interface, for example a system setting, so the upper application queries if the card slot is currently in the closed state or in the pop-out state through the pressure data, wherein the second sensor can include a pressure sensor.

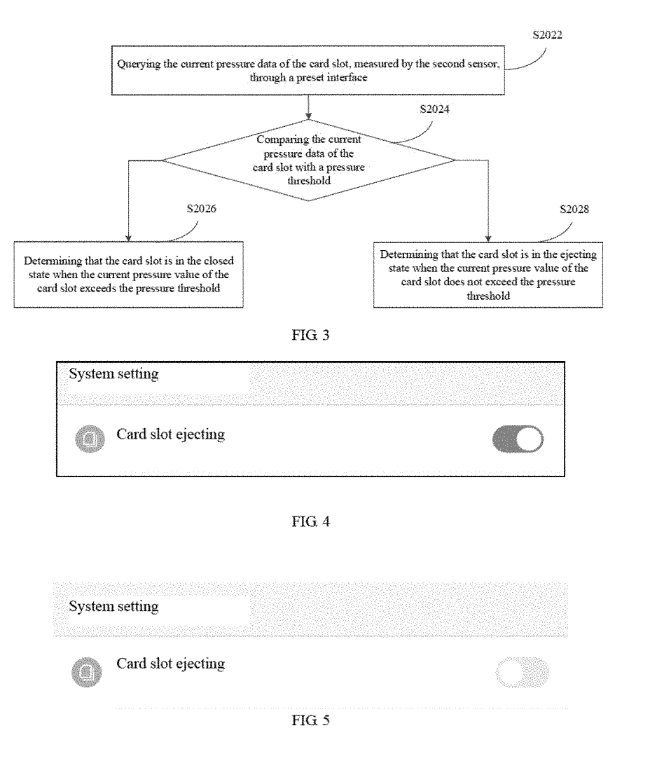

In an optional embodiment of the present disclosure, the step of querying the card slot ate, as shown in FIG. 3, includes the sub-steps as follows.

Step S2022: querying the current pressure data of the card slot, measured by the second sensor, through a preset interface.

The bottom interface is added with the second sensor module, wherein the second sensor can a pressure sensor, and the second sensor is used for measuring the value of the pressure on the card slot, and uploads the measured pressure data via the bottom interface.

By calling a function, the bottom interface queries the current pressure data of the card slot; and a query command is sent to the second sensor so that the second sensor measures the current pressure data of the pressure on the card slot, and feeds back the pressure data.

Step S2024: comparing the current pressure data of the card slot with a pressure threshold.

In the embodiment of the present disclosure, the pressure threshold can be set in advance; the pressure threshold can be set according to an experience value, etc., and is used for determining the state of the card slot; the currently measured value of the pressure on the card slot is obtained by analyzing the pressure data, meaning that, through comparison between the current value of the pressure on the card slot and the pressure threshold, whether the card slot is currently in the closed state or in the ejected state is determined.

Step S2026: determining that the card slot is in the closed state when the current pressure value of the card slot exceeds the pressure threshold.

If the pressure data received by the bottom interface exceeds the pressure threshold, this represents that the card slot is currently in the closed state, and according to the determination result, a card-slot-closed message is generated, and fed back to the upper application.

Step S2028: determining that the card slot is in the ejected state when the current pressure value of the card slot does not exceed the pressure threshold.

If the pressure data received by the bottom interface does not exceed the pressure threshold, this represents that the card slot is currently in the ejected state, and according to the determination result, an ejecting message is generated and fed back to the upper application, namely a card slot state column or control center in the system setting.

The embodiment of the present disclosure also includes representing failure to query the current state of the card slot if failing to receive the pressure data from the second sensor, and sending a prompt message.

For example, the query command can include: query command; the query and determination result can be represented by a binary code, and fed back to the upper application thereof: for example:
0000 0000B represents failing to query the state of the card slot;
0000 0001B represents that the card slot is in the ejected state;
1000 0000B represents that the code slot is in the closed state.

Step S204: generating and displaying state information according to the state of the card slot.

After the current state of the card slot is queried through the bottom interface, the current state information of the card slot is generated according to the query result, wherein the state information includes the ejected state or the closed state; and the current state of the card slot is presented in an icon form according to the generated information.

The display interface is added in the system setting, wherein the display interface includes the prompt message and a state icon; wherein the state icon of the card slot includes a closed state icon and an ejected state icon; for example, the system setting has a newly added card slot state column, and the state column is provided with an ejected state and a dosed state, wherein the two state icons can be changed by sliding or clicking.

As shown in FIG. 4, when it is queried that the card slot is currently in the ejected state, the card slot is presented in the form of the enabled card-slot-out icon. As shown in FIG. 5, when it is queried that, the card slot is currently in the closed state, the card slot is presented in the form of the card-slot-closed icon.

The above is merely a display mode of the state of the card slot. There are many other display modes. The embodiment of the present disclosure does not set a limit in this aspect. For example, the card slot is presented in the form of the enabled card-slot-out or card-slot-closed icon. For another example, two state icons are designed; the first icon represents that the card slot is in the closed state, and the second icon represents that the card is in the ejected state; and a button is designed for sending the ejecting command.

Through calling a function, the bottom interface acquires the measurement data of the sensor, and the state of the card slot is queried and fed back to the upper application; and the upper application realizes display of the card slot state in the form of the functional interface in the system setting or control center of the mobile terminal.

Step S206: receiving a card slot ejecting command when determining that the card slot is closed.

To ensure that the user conveniently controls the card slot to spring out automatically, the system setting of the operating system of the mobile terminal can be configured with a card-slot ejecting system, namely directly displaying the setting of the card slot ejecting in a setting interface, and the user can trigger the setting to send a card slot ejecting command.

For example, the ejecting command is triggered by clicking the card-slot-out icon. For another example, the ejecting command is triggered by manually switching the card state icon from the closed state to the pop-out state.

Wherein, the ejecting command can include: a pop command.

Step S208: generating a control message according to the card slot ejecting command and sending the control message to the mechanical device.

Step S210: controlling the first sensor by the mechanical device according to the control message, wherein the first sensor generates a thrust to spring the card slot out.

After the ejecting command is received, the ejecting command is converted into the control message, and the control message is sent to the mechanical device through the bottom interface, wherein the mechanical device is designed at the position of the card slot; the mechanical device includes the first sensor; and the first sensor can include a thrust sensor. According to the control message, the mechanical device drives the first sensor to generate an instant thrust, and the instant thrust springs the card slot out.

Wherein, the first sensor generates the instant thrust instantaneously; the specific thrust value can be set according to the experience value so that the thrust can push the card slot out while ensuring that the card slot is not completely removed out of the mobile terminal, thus preventing loss or damage of the card slot because the card slot is completely removed out of the mobile terminal by a very large thrust.

Step S212: determining the ejecting result of the card slot according to the sensing data of the second sensor, generating a result message according to the ejecting result and feeding back the result message.

After the card slot is pushed out by the mechanical device, the second sensor detects changes to the pressure on the card slot and uploads the detected changed pressure data, and determines the current state of the card slot through comparing the pressure value with the pressure threshold; if the current value of pressure on the card slot does not exceed the pressure threshold, the second sensor determines that the ejecting of the card slot succeeds; and if the current value of the pressure on the card slot exceeds the pressure threshold, the second sensor determines that the ejecting of the card slot fails, and generates two result messages and feeds back the messages.

Wherein, when the ejecting of the card slot succeeds, the result message representing that the ejecting succeeds is generated, for example, the ejecting message; and when the ejecting of the card slot fails, the result message representing that the ejecting fails is generated, for example, a failure message.

The two result messages are uploaded to the upper application. The upper application makes corresponding response, for example, switching the icon in the card slot state column from the closed state into the ejected state according to the ejecting message; for another example, keeping the icon in, the card slot state column unchanged according the failure message.

Wherein, in order to simplify the message processing process, a logic value can be used to represent the result, for example, 1 or 0, wherein 1 represents the ejecting message, and 0 represents the failure message; or vice versa.

Step S214: determining that the card slot is in the closed state according to the sensing data of the second sensor after the card slot is inserted into a mobile terminal, generating and feeding back a card-slot-in message.

The mobile terminal can actively feedback the current state of the card slot through the second sensor, for example, after the card slot is inserted into the mobile terminal, the pressure on the card slot changes, and the second sensor can uploads the measured current pressure data through the bottom interface; if the current pressure on the card slot exceeds the pressure threshold, the second sensor determines that the card slot is in the inserted state, namely the closed state, then generates the card-slot-in message and sends the card-slot-in message to the upper application; and then the upper application exchanges the state icon of the card slot according to the card-slot-in message.

Wherein, the active feedback order can include: a report order. In order to simplify the message processing process, 1 or 0 can be used for representing the feedback result, for example 1 represents that the card slot is pushed out, and 0 represents that the card slot is inserted.

According to the embodiment of the present disclosure, the sensing data of the second sensor are acquired; the state of the card slot is queried according to the sensing data; the state information is generated according to the state of the card slot and then is displayed; when it is determined that the card slot is in the closed state, the card slot ejecting command is received; the control message is generated according to the card slot ejecting command, and is sent to the mechanical device; the mechanical device controls the first sensor according to the control message; the first sensor generates the thrust to spring the card slot out; the upper application adds a card slot state icon; the state of the card slot can be directly determined through the icon, and a ejecting command can be sent by sliding the icon. Therefore, when the card slot is closed, the mechanical device automatically controls the ejecting of the card slot on the basis of the ejecting command, and it is not needed to manually take out the card slot by using a card pin. The operation is convenient and time is saved.

It is needed to be noted that, for simple description, the method embodiments are described as a series of action combinations, but a person skilled in the art should understands that the embodiments of the present disclosure are not limited by the sequence of the described actions because according to the embodiments of the present disclosure, some steps can be implemented in other sequences or at the same time. Moreover, a person skilled in the art also should understand that the embodiments described in the present disclosure all belong to optimal embodiments, and some actions involved are not always needed by the embodiments of the present disclosure.

### Embodiment 3

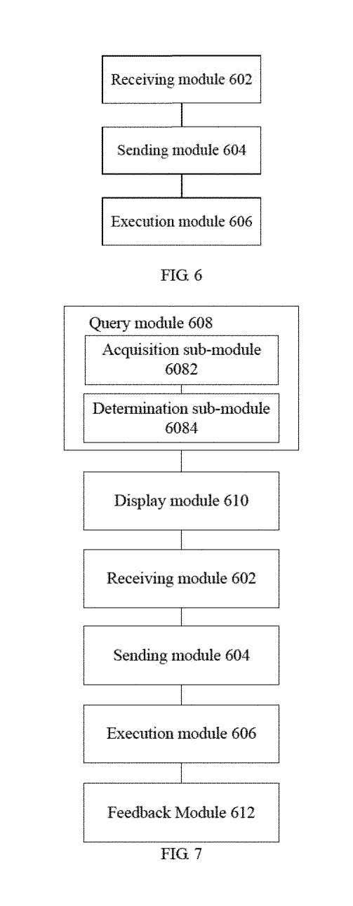

Refer to FIG. 6, which illustrates a structural block diagram of a processing system of a mobile terminal according to an embodiment of the present disclosure. The system may specifically include the following modules:

wherein, the mobile terminal includes a card slot and a mechanical device for controlling the card slot, and the mechanical device is disposed at the position of the card slot;

a receiving module 602, used for receiving a card slot ejecting command when determining that the card slot is closed; a sending module 604, used for generating a control message according to a card slot ejecting command, and sending the control message to a mechanical device; and an execution module 606, used for ejecting the card slot out through a first sensor of the mechanical device.

According to the embodiment of the present disclosure, the receiving module receives the card slot ejecting command when determining that the card slot is closed; the sending module generates the control message according to the card slot ejecting command, and sends the control message to a mechanical device; and the execution module springs the card slot out through the first sensor of the mechanical device, so when the card slot is closed, the mechanical device automatically controls the ejecting of the card slot on the basis of the ejecting command, and it is not needed to manually take out the card slot by using a card pin. The operation is convenient, and time is saved.

The system embodiment is basically the same as the method embodiments and therefore is simply described. Related contents can be seen in the related description of the method embodiments.

### Embodiment 4

Refer to FIG. 7, which illustrates a structural block diagram of a processing system of a mobile terminal according to another embodiment of the present disclosure. The mobile terminal includes a card slot and a mechanical device for controlling the card slot, and the mechanical device is disposed at the position of the card slot; the processing system may include the modules as follows.

A query module 608, used for acquiring sensing data of a second sensor, querying the state of the card slot according to the sensing data, wherein the state of the card slot includes a closed state or an ejected state; a display module 610, used for generating and displaying state information according to the state of the card slot; a receiving module 602, used for receiving a card slot ejecting command when determining that the card slot is closed; a sending module 604, used for generating a control message according to a card slot ejecting command, and sending the control message to a mechanical device; an execution module 606, used for controlling the first sensor by the mechanical device according to the control message, wherein the first sensor generates a thrust to spring the card slot out; a feedback module 612, used for determining the ejecting result of the card slot according to the sensing data of the second sensor, generating a result message according to the ejecting result and feeding back the result message, wherein the ejecting result includes ejecting success and ejecting failure; and a feedback module 612, used for determining that the card slot is in the closed state according to the sensing data of the second sensor after the card slot is inserted into a mobile terminal, generating and feeding back a card-slot-in message.

Wherein, the query module 608 includes an acquisition sub-module 6082, used for querying the current pressure data of the card slot, measured by the second sensor, through a preset interface; a determination sub-module 6084, used for comparing the current pressure data of the card slot with a pressure threshold; when the current pressure value of the card slot exceeds the pressure threshold, determining that the card slot is in the closed state; and when the current pressure of the card slot does not exceed the pressure threshold, determining that the card slot is in the ejected state.

According to the embodiment of the present disclosure, the query module acquires sensing data of the second sensor and queries the state of the card slot according to the sensing data; the card display module generates the state information according to the state of the card slot, and displays the state information; the receiving module receives the card slot ejecting command when determining that the card slot is closed; the sending module generates the control message according to the card slot ejecting command, and sends the control message to a mechanical device; and the execution module springs the card slot out through the first sensor of the mechanical device; an upper application adds a card slot state icon; the display module displays the icon so the state of the card slot can be directly determined, and a ejecting command can be sent by sliding the icon. Therefore, when the card slot is closed, the mechanical device automatically controls the ejecting of the card slot on the basis of the ejecting command, and it is not needed to manually take out the card slot by using a card pin. The operation is convenient, and time is saved.

The device embodiment described above is merely schematic, wherein units described as separable parts may be or may be not physically separated, and components displayed as modules may be or may be not physical modules, which means that the modules can be positioned at one place or distributed on a plurality of network modules. Some or all modules can be selected to fulfill the objective of the solution in the embodiment upon actual demands. A person skilled in the art can understand and implement the present disclosure without creative work.

All embodiments of the present disclosures are described in a progressive manner. Every embodiment focuses on different factors. Identical and similar parts of the embodiments can be referenced to one another.

A person skilled in the art should understand that the embodiments of the present disclosure can be provided as methods, devices or computer program products. Therefore, the embodiments of the present disclosure can be complete hardware embodiments, complete software embodiments or embodiments in combination of software and hardware. Besides, the embodiments of the present disclosure can be one or more computer program products implemented in computer accessible storage media (Including but not limited to magnetic disc memories, CD-ROMs, optical memories, etc.) which contain program codes for computers.

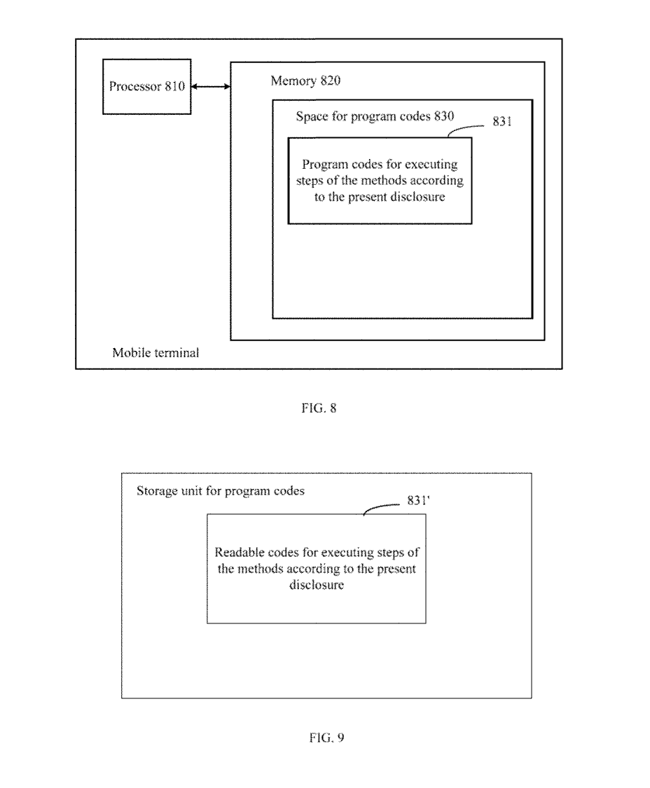

For example, FIG. 8 illustrates a block diagram of a mobile terminal for executing the method according the disclosure. Traditionally, the mobile terminal includes a processor 810 and a computer program product or a computer readable medium in form of a memory 820. The memory 820 could be electronic memories such as flash memory, EEPROM (Electrically Erasable Programmable Read—Only Memory), EPROM, hard disk or ROM. The memory 820 has a memory space 830 for executing program codes 831 of any steps in the above methods. For example, the memory space 830 for program codes may include respective program codes 831 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 9. The memory cells may be provided with memory sections, memory spaces, etc., similar to the memory 820 of the server as shown in FIG. 8. The program codes may be compressed for example in an appropriate form. Usually, the memory cell includes computer readable codes 831′ which can be read for example by processors 810. When these codes are operated on the server, the server may execute respective steps in the method as described above.

The embodiments of the present disclosure are described with reference to the flowcharts and/or block diagrams of the methods and terminal systems (systems) and computer program products of the embodiments of the present disclosure. It should be understood that the computer program commands realize every process and/or block in the flowcharts and/or block diagrams, and the combination of processes and/or blocks in the flowcharts and/or block diagrams. The computer program command can be supplied to the processor of a universal computer, a special computer, an embedded processing machine or other programmable data processing terminal systems to generate a machine, so the commands executed by the processor of the computer or other programmable data processing terminal systems generate a device for realizing specific functions in one or more processes in the flowcharts and/or one or more blocks in the block diagrams.

The computer program commands can also be stored in computer readable memories which guide the computer or other data processing terminal systems to work in a specific mode, so the commands stored in the computer readable memories generate products including command devices, and the command devices conduct specific functions in one or more steps in the flowcharts and/or one or more blocks in the block diagrams.

The computer program commands can also be loaded in the computer or other programmable data processing terminal systems such that the computer or other programmable data processing terminal systems execute a series of operations to generate processing executed by the computer. Thus, the commands executed in the computer or other programmable data processing terminal systems supply steps of conducting specific functions in one or more processes in the flowcharts and/or one or more blocks in the block diagrams.

Although the optimal embodiments of the present disclosure are described, a person skilled in the art can make other changes and modifications on these embodiments when understanding the basic creative concept. Therefore, the protection scope of the claims is interpreted to include the optimal embodiments and all changes and modifications which fall within the embodiments of the present disclosure.

Finally, it is needed to be noted that, in the text, the relationship terms such as the “first” and the “second” are used for merely distinguishing an entity or operation from another entity or operation, and it is not always required or hinted that the entities or operation have such practical relationships or are in such sequences. Besides, the terms “comprise”, “include” or any other synonyms are intended to cover non-exclusive inclusion, so the processes, methods, articles or terminal systems of a series of elements include not only those elements, but also other elements which are not clearly listed, or also include all inherent factors of those processes, methods, articles or terminal systems. In the case of no more limits, the elements defined by the sentence “comprising/including a/an . . . ” should not exclude that the processes, methods, articles or terminal systems including the elements also include other identical elements.

The processing method of a mobile terminal and the processing system of a mobile terminal provided by the present disclosure are described in detail above. In the text, specific examples are used to describe the principle and implementation modes of the present disclosure. The above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A processing method of a mobile terminal, wherein, the mobile terminal comprises a card slot and a mechanical device for controlling the card slot; and the method comprises:
receiving a card slot ejecting command when determing that the card slot is closed;
generating a control message according to the card slot ejecting command, sending the control message to the mechanical device;
and ejecting the card slot out through a first sensor of the mechanical device.

2. The method according to claim 1, Wherein, before determining that the card slot is in the closed state, the method further comprises:
acquiring sensing data of a second sensor, querying the state of the card slot according to the sensing data, wherein the state of the card slot comprises a closed state or an ejected state;
generating and displaying state information according to the state of the card slot.

3. The method according to claim 2, wherein, acquiring sensing data of a second sensor and querying the state of the card slot according to the sensing data comprises:
querying the current pressure data of the card slot, measured by the second sensor, through a preset interface;
comparing the current pressure data of the card slot with a pressure threshold;
determining that the card slot is in the closed state when the current pressure value of the card slot exceeds the pressure threshold;
and determining that the card slot is in the ejected state when the current pressure value of the card slot does not exceed the pressure threshold;

4. The method according to claim 1, wherein, ejecting the card slot out through the first sensor of the mechanical device comprises:
controlling the first sensor by the mechanical device according to the control message, wherein the first sensor generates a thrust to spring the card slot out.

5. The method according to claim 3, wherein, after ejecting the card slot out through the first sensor of the mechanical device, the method further comprises:
determining the ejecting result of the card slot according to the sensing data of the second sensor, generating a result message according to the ejecting result and feeding back the result message, wherein the ejecting result comprises ejecting success or ejecting failure.

6. The method according to claim 5, wherein the method further comprises:
determining that the card slot is in the closed state according to the sensing data of the second sensor after the card slot is inserted, into a mobile terminal, generating and feeding back a card-slot-in message.

7. A mobile terminal, wherein, the mobile terminal comprises: a card slot;
a mechanical device for controlling the card slot;
at least one processor; and
a memory communicably connected with the at least one processor for storing instructions executable by the at least one processor, wherein execution of the instructions by the at least one processor causes the at least one processor to:
receive a card slot ejecting command when determining that the card slot is closed;
generate a control message according to the card slot ejecting command, and sending the control message to the mechanical device;
eject the card slot out through a first sensor of the mechanical device.

8. The mobile terminal according to claim 7, wherein execution of the instructions by the at least one processor causes the at least one processor to:
acquire sensing data of a second sensor, query the state of the card slot according to the sensing data wherein the state of the card slot comprises a closed state or an ejected state;
generate and display state information according to the state of the card slot.

9. The mobile terminal according to claim 8, wherein acquire sensing data of a second sensor, query the state of the card slot according to the sensing data comprises:
query the current pressure data of the card slot, measured by the second sensor, through a preset interface;
compare the current pressure data of the card slot with a pressure threshold; when the current pressure value of the card slot exceeds the pressure threshold, determine that the card slot is in the closed state; and when the current pressure of the card slot does not exceed the pressure threshold, determine that the card slot is in the ejected state.

10. The mobile terminal according to claim 7, wherein,
spring the card slot out through a first sensor of the mechanical device comprises control the first sensor by the mechanical device according to the control essage, arld the first sensor generates a thrust to spring the card slot out.

11. The mobile terminal according to claim 9, wherein execution of the instructions by the at least one processor causes the at least one processor to:
determine the ejecting result of the card slot according to the sensing data of the second sensor, generate a result message according to the ejecting result and feeding back the result message, wherein the ejecting result comprises ejecting success or ejecting failure.

12. The mobile terminal according to claim 11, wherein,
determine that the card slot is in the closed state according to the sensing data of the second sensor after the card slot is inserted into a mobile terminal, generate and feed back a card-slot-in message.

13. A non-transitory computer readable medium storing executable instructions that, when executed by a mobile terminal, cause the mobile terminal to:
receive a card slot ejecting command when determining that the card slot is closed;
generate a control message according to the card slot ejecting command, and sending the control message to the mechanical device;
ejecting the card slot out through a first sensor of the mechanical device.
